(19) United States
(12) Patent Application Publication
(10) Pub. No.: US 2013/0215756 A1
(43) Pub. Date: Aug. 22, 2013

(54) APPARATUS AND METHOD FOR MANAGING CONTENTS CACHE CONSIDERING NETWORK COST

(71) Applicant: Electronics and Telecommunications Research Institute, (US)

(72) Inventors: Hong Seok JEON, Daejeon (KR); Byung Joon LEE, Daejeon (KR); In Sang CHOI, Daejeon (KR); Ho Young SONG, Daejeon (KR)

(73) Assignee: Electronics and Telecommunications Research Institute, Daejeon (KR)

(21) Appl. No.: 13/769,668

(22) Filed: Feb. 18, 2013

(30) Foreign Application Priority Data
Feb. 17, 2012 (KR) 10-2012-0016624
Jan. 11, 2013 (KR) 10-2013-0003316

(51) Int. Cl. H04L 12/56

(52) U.S. Cl. CPC H04L 47/12
USPC 370/238

(57) ABSTRACT

Provided is a content cache managing method and apparatus, and more particularly, a method and an apparatus for managing a content cache by considering network cost in a network. A content cache managing method of transmission equipment that forwards a content data packet may include calculating a cache replacement factor value by using network cost that is incurred in a network path from the transmission equipment to an original content server storing original content data, based on the content data packet that the content data packet is received from neighboring transmission equipment, and managing a cache in the transmission equipment based on the calculated cache replacement factor value or a state of cache in the transmission equipment to store the content data packet.

### CROSS-REFERENCE TO RELATED APPLICATIONS

This application claims priority to and the benefit of Korean Patent Application No. 10-2012-0016624 filed in the Korean Intellectual Property Office on Feb. 17, 2012, and Korean Patent Application No. 10-2013-0003316 filed in the Korean Intellectual Property Office on Jan. 11, 2013,the entire contents of which are incorporated herein by reference.

### TECHNICAL FIELD

The present invention relates to a content cache managing method and apparatus, and more particularly, to a method and an apparatus for managing a content cache by considering network cost in a network.

### BACKGROUND ART

An Internet structure has deviated from an original structure that was designed as a communication service between hosts, and has been changed to a new Internet structure based on content and thereby used. In regards to the many research results about the above structure, a clean-state approach scheme such as content centric networking (CCN) or data-oriented network architecture (DONA) is proposed. One of the proposed characteristics is to support on-path caching. On-path caching is one of the in-network caching methods in which network transmission equipment positioned in a transmission path of content data temporarily caches and stores the incoming content and later provides the content from a caching memory of the network transmission equipment when a request for the same content is received. In general, in on-path caching, the content is divided based on a predetermined size of a chunk unit and thereby stored.

However, in such caching method, when a storage space temporarily becomes full for the cache, cache replacement needs to occur in order to store new information. In the case of the above replacement, a replacement method is determined according to a content cache replacement policy. The content cache replacement policy refers to a method of replacing existing cached content with new content in order to cache the new content when additional storage is absent in a cache memory having limited capacity. A representative content cache replacement policy includes a least recently used (LRU) caching policy, a least frequently used (LFU) caching policy, and a first in first out (FIFO) caching policy.

The above LRU, LFU, and FIFO caching policies are originally designed to be used in a cache present for high speed data transmission between a central processing unit (CPU) within a system and a memory or between the CPU and a hard disk. On the other hand, in on-path caching, a cache is positioned in the overall network that connects a client and a content providing server (an origin server). Therefore, an effect of the cache on the network differs based on performance of a cache replacement policy. For example, when a cache miss about predetermined content occurs in on-path caching, network cost for receiving the content from the content providing server occurs.

### SUMMARY OF THE INVENTION

The present invention has been made in an effort to provide a content cache managing method and apparatus that may minimize network cost incurred due to a cache miss in on-path caching.

An exemplary embodiment of the present invention provides a content cache managing method of transmission equipment that constitutes a content delivering network, the method including calculating a cache replacement factor value that occurs in a network path from the transmission equipment to a content server based on a content data packet so that the transmission equipment may cache incoming content in a storage space of the transmission equipment, and managing a cache in the transmission equipment based on the calculated cache replacement factor value or a state of cache in the transmission equipment to store the content.

The calculating may calculate the cache replacement factor value based on network cost information including a hop count through which the content data packet passes between the transmission equipment and the content server.

The managing may determine cache data (content data stored in the cache) to be deleted using the cache replacement factor value when a cache storage space of the transmission equipment to store the content is full, and may replace the determined cache data to be deleted with the content to be newly added.

When new content is cached, the cached new content may be stored in the cache together with the calculated cache replacement factor value.

Cache data having the smallest cache replacement factor value among a collection of data in the cache may be determined as the cache data to be deleted.

A header of the content data packet may include network cost information including hop count information.

According to exemplary embodiments of the present invention, transmission equipment may minimize network cost averagely required to get the content by considering, as a cache replacement factor in on-path caching, the network cost as well as usage recency or frequency of the content, and may increase efficiency and effectiveness of on-path caching by enabling various content to be distributed in the overall network.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a configuration diagram of a system applicable with a content cache managing apparatus according to an exemplary embodiment of the present invention.

FIG. 2 is a configuration diagram of a content cache managing apparatus according to an exemplary embodiment of the present invention.

FIG. 3 is a flowchart of a method of managing a content cache by a content cache managing apparatus according to an exemplary embodiment of the present invention.

FIG. 4 is a diagram illustrating a method of calculating a cache replacement factor value by considering network cost according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, a method and an apparatus for managing a content cache by considering network cost in a network according to exemplary embodiments of the present invention will be described in detail with reference to the accompanying drawings.

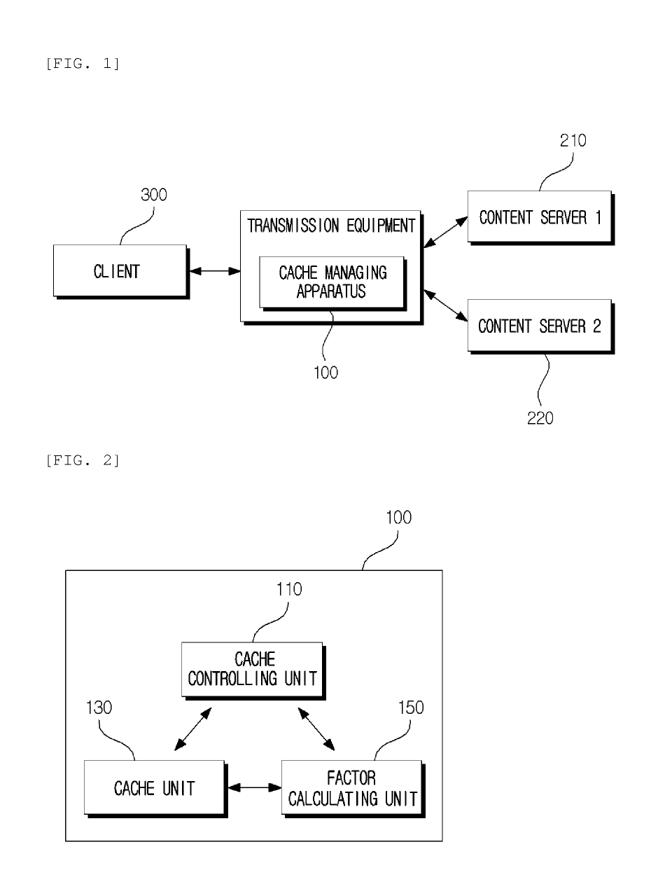

FIG. 1 is a configuration diagram of a system applicable with a content cache managing apparatus according to an exemplary embodiment of the present invention.

Referring to FIG. 1, a cache managing apparatus 100 of transmission equipment positioned in a transmission path of content data includes a cache that is a storage space capable of temporarily storing a content data packet. The cache managing apparatus 100 may temporarily store, in the cache, content data packets that are transmitted from a content server (1) 210 and a content server (2) 220, and later may provide the content from the cache when a request packet for the same content is received.

Accordingly, when a content data packet is received, the cache managing apparatus 100 of the transmission equipment may verify whether caching information about the received content data packet is present within the cache in the cache managing apparatus 100. Caching information about content may include content data and a cache replacement factor value used to identify a deletion priority between the cache data in order to select cache data to be deleted within the cache.

When caching information about the received content data packet is absent in the cache within the cache managing apparatus 100 of the transmission equipment, the cache managing apparatus 100 may calculate the cache replacement factor value from the received content data packet. The cache replacement factor value of the content data packet may be calculated using network cost that is incurred in a path from the transmission equipment to a content server.

To calculate the network cost of a content data packet 1 transmitted from the content server (1) 210 and a cache replacement factor value of a content data packet 2 transmitted from the content server (2) 220, the cache managing apparatus 100 may calculate and use hop counts through which the content data packet 1 and the content data packet 2 pass between the transmission equipment and the content server (1) 210 and between the transmission equipment and the content server (2) 220, respectively. The cache managing apparatus 100 may calculate the network cost by using a link weight that a network operator dynamically assigns to each link based on a network operation policy or a network state, such as a traffic engineering metric or an Interior Gateway Protocol (IGP) metric

That is, the cache managing apparatus 100 may calculate the network cost using a sum of weights assigned to links through which a content data packet passes between the transmission equipment and a content server, or using network cost that is calculated by simultaneously considering a hop count and a link weight.

After calculating the cache replacement factor value, the cache managing apparatus 100 may check whether the cache in the cache managing apparatus 100 has extra capacity capable of storing a new content data packet. When the storage capacity of the cache is sufficient, the cache managing apparatus 100 may store the received content data packet. Meanwhile, the cache managing apparatus 100 may include and manage the cache queue list that is a list about the cache replacement factor value.

However, when the storage capacity within the cache is full, the cache managing apparatus 100 may determine, as a replacement target, cache data having the smallest cache replacement factor value among a collection of data in the cache using the calculated cache replacement factor value. The cache managing apparatus 100 may delete the determined cache data from the cache, and may store the received content data packet and the cache replacement factor value in the cache in the cache managing apparatus 100.

When a transmission node receives a content request packet from a client 300, and when the requested content data packet is present as cache data of the cache managing apparatus 100, the cache managing apparatus 100 may update usage information about the cache data.

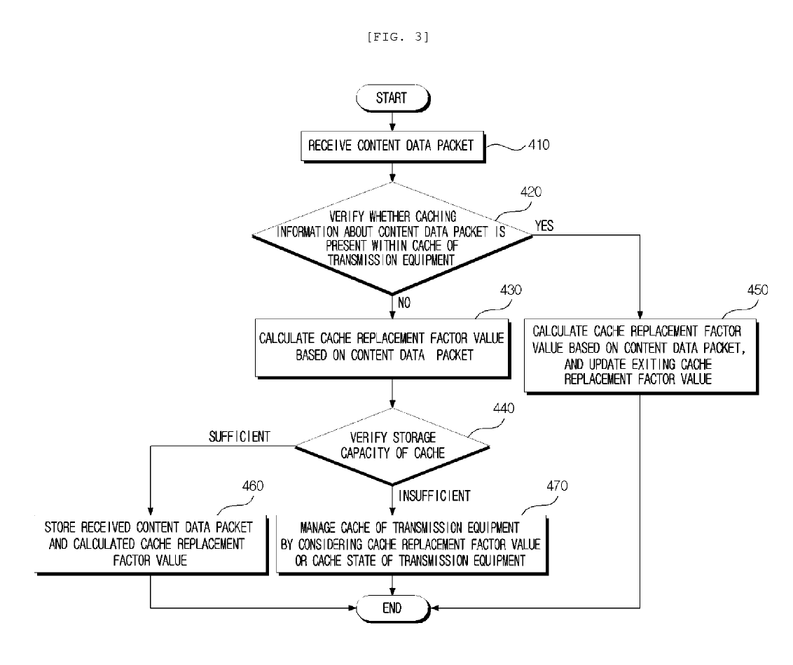

FIG. 2 is a configuration diagram of a content cache managing apparatus according to an exemplary embodiment of the present invention.

Referring to FIG. 2, when transmission equipment receives a content request packet from the client 300 or receives a content data packet from neighboring transmission equipment, a cache controlling unit 110 verifies whether caching information about the content request packet/content data packet is stored within a cache unit 130 of the transmission equipment.

When caching information about the received content request packet is absent in the cache unit 130, the cache controlling unit 110 ignores the received content request packet. In this case, a transmission node may forward the content request packet to a content server that provides the requested content, based on predetermined routing information.

When caching information about the received content data packet is absent in the cache unit 130, the cache controlling unit 110 may manage a factor calculating unit 150 to calculate a cache replacement factor value using the received content data packet. To calculate the cache replacement factor value of the received content data packet, the factor calculating unit 150 may use, from the content data packet, a network cost value that is incurred in a path from the transmission equipment to the content server.

To calculate the network cost, the factor calculating unit 150 may use a hop count through which the content data packet passes between the transmission equipment and the content server. The factor calculating unit 150 may calculate the network cost by using a link weight that a network operator dynamically assigns to each link based on a network operation policy or a network state, such as a traffic engineering metric or an IGP metric. The factor calculating unit 150 may calculate the network cost with a sum of weights assigned to links through which the content data packet passes between the transmission equipment and the content server, or may use a network cost value that is calculated by simultaneously considering the hop count and the link weight.

When the factor calculating unit 150 calculates the cache replacement factor value of the content data packet, the factor calculating unit 150 may transmit the calculated cache replacement factor value to the cache controlling unit 110. When the cache controlling unit 110 receives the cache replacement factor value, the cache controlling unit 110 may check whether the cache unit 130 has sufficient extra capacity capable of storing new content data packet data. Meanwhile, the cache controlling unit 110 may include the cache queue list to manage the cache replacement factor value.

When the storage capacity of the cache unit 130 is sufficient, the cache controlling unit 110 may store the received content data packet and the calculated cache replacement factor value in the cache unit 130 and may update the cache queue list.

When the storage capacity of the cache unit 130 is full, the cache controlling unit 110 may determine cache data to be replaced in the cache unit 130 in order to secure a space for storing new content data packet data. The cache controlling unit 110 may determine cache data to be replaced by further considering the calculated cache replacement factor value, network cost, link weight information, and usage information of the content.

The cache controlling unit 110 may compare the cache replacement factor value, calculated in correspondence to the content data packet received by the factor calculating unit 150, with a cache replacement factor value corresponding to cache data within the cache unit 130, and may determine cache data corresponding to a relatively small cache replacement factor value as a target to be deleted. Meanwhile, to determine a replacement target having the smallest cache replacement factor value within the cache, the cache controlling unit 110 may use the cache queue list that is provided in the cache controlling unit 110.

When cache data to be deleted is determined, the cache controlling unit 110 deletes the cache data and secures a storage space. The received content data packet and the calculated cache replacement factor value may be stored in the storage space secured within the cache unit 130, and the cache replacement factor value of the content data packet may be updated to the cache controlling unit 110.

When caching information about corresponding content is present in the cache unit 130, the cache controlling unit 110 may update the cache replacement factor value of the content stored in the cache unit 130 and the cache queue list using the cache replacement factor value that is calculated from the newly received content data packet.

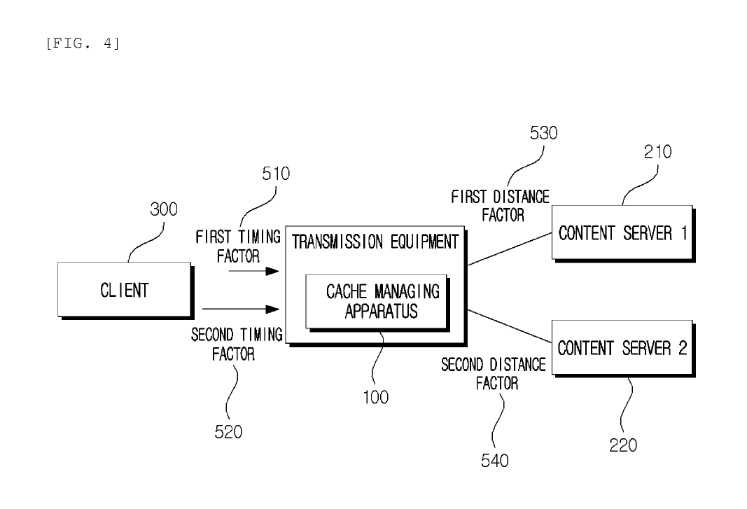

FIG. 3 is a flowchart of a method of managing a cache by a content cache managing apparatus according to an exemplary embodiment of the present invention.

Referring to FIG. 3, a content request packet is received from a client or a content data packet is received from neighboring transmission equipment (410). When caching information about the received content request packet is absent in a cache, the received content request packet is ignored. In this case, a transmission node may forward the content request packet to a content server that provides the requested content, based on predetermined routing information.

When the content data packet is received from the neighboring transmission equipment or the content server, transmission equipment verifies whether caching information about the content data packet is present within the cache in the transmission equipment (420). Caching information may include content data and a cache replacement factor value used to identify a deletion priority between the cache data in order to select cache data to be deleted within the cache.

When caching information about the received content data packet is present, a cache replacement factor value is newly calculated from the content data packet, and the newly calculated cache replacement factor value is used to update the cache and the cache queue list that is a list for managing the cache replacement factor value (450).

To calculate the cache replacement factor value, it is possible to use network cost utilizing a sum of weights assigned to links through which the content data packet passes between the transmission equipment and the content server, or to use network cost that is calculated by simultaneously considering a hop count and a link weight. The cache replacement factor value may be calculated by using, as the network cost, a link weight that a network operator dynamically assigns to each link based on a network operation policy or a network state, such as a traffic engineering metric or an IGP metric.

When caching information about the received content data packet is absent within the cache, the cache replacement factor value is calculated from the received content data packet (430) and it is verified whether storage capacity of the cache in the transmission equipment to store the calculated cache replacement factor value and the received content data packet is sufficient (440). When the storage space is sufficient, the received content data packet is stored in the cache and the calculated cache replacement factor value is updated (460). However, when the storage capacity is full within the cache in the transmission equipment, cache data to be deleted within the cache may be determined using the cache replacement factor value.

To determine cache data to be deleted within the cache, information including the network cost, link weight information, usage information of content may be additionally further considered. When a cache replacement factor value corresponding to cache data within the cache is smallest through comparison with the cache replacement factor value of the received content data packet, the cache data having the smallest cache replacement factor value may be determined as a target to be deleted.

Meanwhile, to determine cache data to be deleted having the smallest cache replacement factor value corresponding to cache data stored in the cache, the cache queue list may be used. When cache data to be deleted is determined, the determined cache data may be deleted and a new content data packet and the calculated cache replacement factor value may be stored. The calculated cache replacement factor value may be updated to the cache queue list (470).

FIG. 4 is a diagram illustrating a method of calculating a cache replacement factor value by considering network cost according to an exemplary embodiment of the present invention.

Referring to FIG. 4, a first timing factor 510 about content 1 between a client 300 and transmission equipment and a second timing factor 520 about content 2 may be assumed as items to be considered for network cost. A first distance factor 530 that is a distance factor about the content 1 and a second distance factor 540 that is a distance factor about the content 2 may be assumed as distance factors between the transmission equipment and a content server. Usage frequency of a content data packet or last usage time of content may be included as an example of the first timing factor 510 and the second timing factor 520 between the client 300 and the transmission equipment. A hop count value of a network of the content data packet between the transmission equipment and the content server (1) 210 or the content server (2) 220 may be included as an example of the first distance factor 530 or the second distance factor 540 that is a distance factor between the transmission equipment and the content server (1) 210 or the content server (2) 220.

According to an exemplary embodiment about a method of calculating a cache replacement factor value by considering network cost, the first timing factor 510 may be usage frequency of the content 1 or last usage time of the content 1, the second timing factor 520 may be usage frequency of the content 2 or last usage time of the content 2, the first distance factor 530 may be a hop count value of a content data packet from the transmission equipment to the content server (1) 210 of the content 1, and the second distance factor 540 may be a hop count value of a content data packet from the transmission equipment to the content server (2) 220 of the content 2.

Accordingly, a cache replacement factor value of the content 1 may be a value that is obtained by multiplying the first timing factor 510 and the first distance factor 530 from the transmission equipment to the content server (1) 210, and a cache replacement factor value of the content 2 may be a value that is obtained by multiplying the second timing factor 520 and the second distance factor 540 from the transmission equipment to the content server (2) 220.

In the case of assigning different weights to the first timing factor 510, the second timing factor 520, the first distance factor 530 from the transmission equipment to the content server (1) 210, and the second distance factor 540 from the transmission equipment to the content server (2) 220, when a weight of a timing factor is α and a weight of a distance factor from the transmission equipment to the content server (210 or 220) is β, the cache replacement factor value of the content 1 may be calculated by further multiplying αβ and a value that is obtained by multiplying the first timing factor 510 and the first distance factor 530 from the transmission equipment to the content server (1) 210. The cache replacement factor value of the content 2 may be calculated by further multiplying αβ and a value that is obtained by multiplying the second timing factor 520 and the second distance factor 540 from the transmission equipment to the content server (2) 220.

According to another exemplary embodiment about a method of calculating a cache replacement factor value by considering network cost, the cache replacement factor value of the content 1 may be a value that is obtained by adding up the first timing factor 510 and the first distance factor 530 from the transmission equipment to the content server (1) 210, and the cache replacement factor value of the content 2 may be a value that is obtained by adding up the second timing factor 520 and second distance factor 540 from the transmission equipment to the content server (2) 220. In the case of assigning different weights to the first timing factor 510, the second timing factor 520, the first distance factor 530 from the transmission equipment to the content server (1) 210, and the second distance factor 540 from the transmission equipment to the content server (2) 220, when a weight of a timing factor is a and a weight of a distance factor of a content data packet from the transmission equipment to a content server (210 or 220) is β, the cache replacement factor value of the content 1 may be calculated by adding up a value that is obtained by multiplying the first timing factor 510 and a, and a value that is obtained by multiplying the first distance factor 530 of the content data packet from the transmission equipment to the content server (1) 210 and β. The cache replacement factor value of the content 2 may be calculated by adding up a value that is obtained by multiplying the second timing factor 520 and α, and a value that is obtained by multiplying the second distance factor 540 of the content data packet from the transmission equipment to the content server (2) 220 and β.

Meanwhile, based on the assumption that the transmission equipment is aware of connection information with the neighboring transmission equipment of the transmission equipment, when a content data packet is received from a predetermined interface, a result of inquiring about link weight information that is assigned to the interface from which content is received may be used as a link weight value. The transmission equipment may explicitly specify the link weight information in the content data packet using the link weight value.

For example, in CCN, it is possible to add link weight information by expanding DATA message that CCN introduces. The DATA message may indicate a packet delivering the requested content as a response. Accumulated metric values may be included in a header of the DATA message as an additional field to indicate accumulated weights of links used for forwarding content.

When the content server (210 or 220) transmits a DATA message, a value of an accumulated metric value field of the header of the DATA message may be set to “0”. When receiving the DATA message, the cache managing apparatus 100 of transmission equipment such as a router may add and thereby update a weight value of a reception link to the value of the accumulated metric value field of the header of the DATA message.

For example, in a case in which a value of an accumulated metric value field of a header of a received DATA message is “10”, and a weight value of a link used to receive the DATA message is “2”, when transmitting the DATA message, the cache managing apparatus 100 of the transmission equipment may update the value of the accumulated metric value field of the header to “12(=10+2)”.

When caching content in the received DATA message, the cache managing apparatus 100 of the transmission equipment may also store the updated value of the accumulated metric value field. When the cache managing apparatus 100 of the transmission equipment has a content request packet requested by the client 300 in a cache form, the cache managing apparatus 100 of the transmission equipment may directly provide the client 300 with the requested content through the DATA message. Here, the generated value of the accumulated metric value field of the header of the DATA message may use the aforementioned accumulated metric values stored when receiving the content.

In a CCN, it is possible to add hop count information by expanding the DATA message. Hop count information may be included in a header of the DATA message as an additional field to indicate network cost associated with content forward. When the content server (210 or 220) transmits a DATA message, a value of a hop count information field of the header of the DATA message may be set to “1”. Every time the DATA message is forwarded, the cache managing apparatus 100 of the transmission equipment such as a router may increase a value of the hop count field of the header by “1”. When caching content in the received DATA message, the cache managing apparatus 100 may also store a hop count value. When the cache managing apparatus 100 has content requested by the client 300 in a cache form, the cache managing apparatus 100 may directly provide the client 300 with the requested content through the DATA message. Here, the generated value of the hop count field of the header of the DATA message header may use the aforementioned hop count value stored when receiving the content.

Meanwhile, in order to calculate a cache replacement factor value by using network cost that is calculated by considering both hop counts and a sum of weights assigned to links through which the content data packet passes, it is possible to define the DATA message that includes all of a hope count and an accumulated metric value as additional fields.

A method of calculating a cache replacement factor value using values of two fields may also calculate the cache replacement factor value using a value that is obtained by adding up a result value of a cache replacement factor value calculating scheme using only a hop count and a result value of a cache replacement factor value calculating scheme using a link weight.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A content cache managing method of transmission equipment that forwards a content data packet, the method comprising:
calculating, by a factor calculating unit, a cache replacement factor value by using network cost that is incurred in a network path from the transmission equipment to an original content server storing original content data, based on the content data packet that the transmission equipment receives from neighboring transmission equipment; and
managing, by a cache controlling unit, a cache in the transmission equipment based on the calculated cache replacement factor value or a state of cache in the transmission equipment to store the content data packet.

2. The method of claim 1, wherein the managing updates an existing cache replacement factor value or newly stores the incoming content data packet and its cache replacement factor value depending on whether the incoming content data packet is present in the transmission equipment as a cache.

3. The method of claim 1, wherein the calculating calculates the cache replacement factor value by using network cost information including a hop count through which the content data packet passes between the transmission equipment and the original content server.

4. The method of claim 2, wherein, in the case of storing the incoming content data packet and its cache replacement factor value, when a cache storage in the transmission equipment is full, cache data to be deleted is determined using the calculated cache replacement factor value and the determined cache data is replaced with a new content data packet.

5. The method of claim 4, wherein, in the case of storing the incoming content data packet, the content data packet is stored by further including the calculated cache replacement factor value.

6. The method of claim 4, wherein cache data having the smallest cache replacement factor value among a collection of data in the cache is determined as the cache data to be deleted.

7. The method of claim 1, wherein a header of the content data packet includes a network cost information field including hop count information.

8. A content cache managing apparatus of transmission equipment that forwards a content data packet, the apparatus comprising:
a cache unit to store the content data packets;
a factor calculating unit to calculate a cache replacement factor value by using network cost that is incurred in a network path from the cache unit to an original content server storing original content, based on the incoming content data packet; and
a cache controlling unit to manage the cache unit based on caching information about the incoming content data packet in the cache unit, the cache replacement factor value of the incoming content data packet, or storage capacity of the cache unit.

9. The apparatus of claim 8, wherein the cache controlling unit updates an existing cache replacement factor value, stores both the content data packet and the cache replacement factor value in the cache unit, or updates the calculated cache replacement factor value, depending on whether caching information about the content data packet is present in the cache unit.

10. The apparatus of claim 8, wherein the factor calculating unit calculates the cache replacement factor value by using network cost information including a hop count through which the content data packet passes between the cache unit and the original content server.

11. The apparatus of claim 9, wherein, in the case of storing the content data packet and its cache replacement factor value in the cache unit, the cache controlling unit updates an existing cache replacement factor value and stores the incoming content data packet, or determines cache data to be deleted using the cache replacement factor value and stores a new content data packet by deleting the determined cache data, based on a storage space of the cache unit to store the content data packet.

12. The apparatus of claim 11, wherein, in the case of storing the new content data packet, the cache controlling unit stores the new content data packet by further including the calculated cache replacement factor value and updates a cache queue list.

13. The apparatus of claim 11, wherein the cache controlling unit determines cache data having the smallest cache replacement factor value among a collection of data in the cache as the cache data to be deleted.

14. The apparatus of claim 8, wherein a header of the content data packet includes a network cost information field including hop count information.
